(19) United States
(12) Patent Application Publication
(10) Pub. No.: US 2019/0127066 A1
(43) Pub. Date: May 2, 2019

(54) REMOTE-CONTROLLED UNMANNED FOLDABLE AIRCRAFT

(71) Applicant: DIODON DRONE TECHNOLOGY, Toulouse (FR)

(72) Inventors: Antoine Jacques Mistral Tournet, Toulouse (FR); Roman Guillaume Jullen Ludani, Toulouse (FR); Marco Lopez, Lacroix-Falgarde (FR); Tom Patrick Lolies, Bernin (FR)

(21) Appl. No.: 16/080,237

(22) PCT Filed: Feb. 28, 2017
(86) PCT No.: PCT/EP2017/054609

§ 371 Date: Aug. 27, 2018

(30) Foreign Application Priority Data
Mar. 3, 2016 (FR) 1651800

(51) Int. Cl. B64C 39/02; B64C 1/34

(52) U.S. Cl. CPC B64C 39/024; B64C 1/34; B64C 2201/027; B64C 2201/203; B64C 2201/042; B64C 2201/146; B64C 2201/165; B64C 2201/108

(57) ABSTRACT

A remote-controlled unmanned foldable aircraft comprises at least two motors that allow the aircraft to fly, and at least one support structure for supporting said motors; the support structure is flexible and inflatable such that the support structure can be folded and unfolded between a storage position and an operational position.

### TECHNICAL FIELD

The present invention relates to the field of unmanned remote-controlled aircraft that are known to a person skilled in the art as “drones”. The present invention relates more particularly to drones that can be transported by a single user, in a backpack for example.

A remote-controlled unmanned aircraft, hereinafter called a drone, comprises a rigid structure on which are mounted several motors, generally four motors, in particular for the purpose of flying the drone after a vertical take-off. The drone also comprises a management module attached to the rigid structure of the drone and configured to receive wireless commands to control the motors according to the commands received. The user can therefore control the drone in flight, for example, by using a remote control or a phone. In a known manner, the drone can also comprise recording equipment (video camera, etc.) secured to the rigid structure of the drone and functionally connected to the management module. In a known manner, the management module also comprises a battery to electrically power the motors and equipment of the drone.

To allow the user to easily transport a drone to the site where it will be used, a known practice is to make small-sized drones. However, if the size of the drone is too small, the stability thereof can be reduced. A drone that is foldable from a storage position, with a reduced size, to an operational position, with a significant size, is a known practice. As an example, the rigid structure of the drone comprises several articulated arms that rely on hinges to limit the size of the drone when it is stored. In practice, the motors of the drone are secured to the ends of the articulated arms and fold back towards the centre of the drone in the storage position.

Such foldable drones have many disadvantages. Indeed, the articulated arms are fragile and are easily damaged in the case of an impact. Furthermore, the hinges are exposed to wear, which deforms the arm in an extended position. Such a deformation is detrimental, as it impacts the positioning and orientation of the axes of the motors, which harms the behaviour of the drone when in flight (stability, etc.).

The purpose of the invention is therefore to remedy some of these disadvantages by proposing an unmanned, remote-controlled, impact-resistant, easily-transportable aircraft that is of simple manufacturing.

Incidentally, the patent application WO2014207732 describes a drone featuring an inflatable structure, but the drone is not foldable.

### SUMMARY

For this purpose, the invention relates to an unmanned remote-controlled and foldable aircraft comprising at least two motors adapted to fly the aircraft, and at least one support structure configured to support said motors.

The invention is notable in that the support structure is flexible and inflatable so as to allow folding of said support structure from a storage position to an operational position.

With the invention, the aircraft can be folded in a practical manner because, once it is deflated, the support structure has several folding points according to different and varied angles. Therefore, in storage position, the aircraft can be stored in different container types and in particular in a conventional backpack. Advantageously, the support structure can cover all the motors for the protection thereof during transport, which extends the lifespan thereof. Furthermore, an inflatable support structure provides great resistance to impacts and is configured to float on the surface of water.

Preferably, the support structure comprises a plurality of inflatable branches, at least one motor being secured to each inflatable branch. Therefore, the branches ensure that the motors are suitably spaced, thereby increasing the scope of the aircraft when it is being used. Furthermore, such an inflatable branch allows for greater lengthwise folding freedom. Preferably, each branch extends axially.

Preferably, each motor is secured to the end of an inflatable branch to maximise the scope thereof in an operational position, thereby improving the stability thereof.

More preferably still, as each inflatable branch extends axially, each motor is secured to the upper surface or to the lower surface of an inflatable branch of the structure. In other words, the motor does not extend along the axis of said branch. With the axial ends of the branches being inflatable, they can advantageously withstand impacts, thereby increasing the lifespan of the aircraft.

In a preferred manner, the inflatable branches are configured in a star shape so that the motors are evenly distributed around the aircraft.

In a preferred embodiment, the aircraft comprises a management module connected to the motors by a plurality of basic electric cables. The management module is used to control said motors. In a preferred manner, the management module comprises a supply battery.

Preferably, the management module comprises a rigid member secured to the support structure to accurately position the inflatable branches with respect to one another. Preferably, said rigid member has a star-shaped configuration.

Preferably, the support structure comprises an inner inflatable shell and an outer protective shell. Therefore, the inner shell is free to undergo deformation while being protected by the outer shell. Preferably, the inner shell is extensible whereas the outer shell is not extensible. Therefore, the size of the support structure in an operational position is defined by the outer shell. The outer shell is the structural element of the aircraft, and transfers the mechanical stress generated by the motors.

Preferably, the outer shell has a circular cross-section to evenly distribute the stresses of the inner inflatable shell to the inner surface of the outer shell.

Preferably, the support structure comprises at least one basic electric cable arranged between the inner inflatable shell and an outer protective shell. This arrangement enables the support structure to be folded with the electrical connection.

Preferably, each inflatable branch comprises opening means to provide access to the inner volume of said inflatable branch. The user can therefore easily access the motor assembly location, which is advantageous in terms of maintenance. Preferably, the opening means allows access to the inner volume of the outer protection shell. Also, preferably, the opening means allows access to the inner volume of the inner inflatable shell.

Preferably, the opening means is situated in the vicinity of the motor assembly location, preferably at the level of the end of the inflatable branch. Preferably, as the branch extends axially, the opening means is located at the level of the axial end of the inflatable branch.

Preferably, each inflatable branch comprises a rigid member to attach a motor. Therefore, the motor is secured in a reliable and accurate manner to an attachment member, which remains rigid even in the storage position. The attachment member guarantees the parallelism of the motor axes in the operational position.

Preferably, said attachment member is secured to the outer protection shell. In other words, the attachment member serves as a positioning interface of the motor on the outer shell to guarantee accurate positioning. In a preferred manner, the attachment member is mounted in a housing of the outer protection shell, in particular in a sheath. More preferably still, the attachment member is secured to the upper or lower surface of the outer shell. More preferably still, the attachment member is curved to fit with the shape of the outer surface of the inflatable branch in an operational position.

In a preferred embodiment, the aircraft comprises only four motors to create a compromise between performance and compactness.

### BRIEF DESCRIPTION OF THE DRAWINGS

The invention will be best understood upon reading the following description, provided solely as an example, and with reference to the appended figures, wherein:

FIGS. 1 and 2 are schematic representations of an unmanned remote-controlled aircraft according to an embodiment of the invention in an operational position;

FIGS. 3A, 3B are schematic representations of the aircraft of FIGS. 1 and 2 in a storage position, seen from below and from above;

FIGS. 4A and 4B are cross-section views of a mid-portion of a branch of the structure of the aircraft in the storage position and in the operational position;

FIG. 5 is a schematic representation of an end of a branch equipped with a motor; and

FIGS. 6 and 7 are perspective and cross-section views of the attachment means of the motor to an end of a branch.

It must be noted that the figures provide a detailed view of the invention to illustrate the implementation thereof, said figures naturally being provided to better define the invention as necessary.

### DETAILED DESCRIPTION

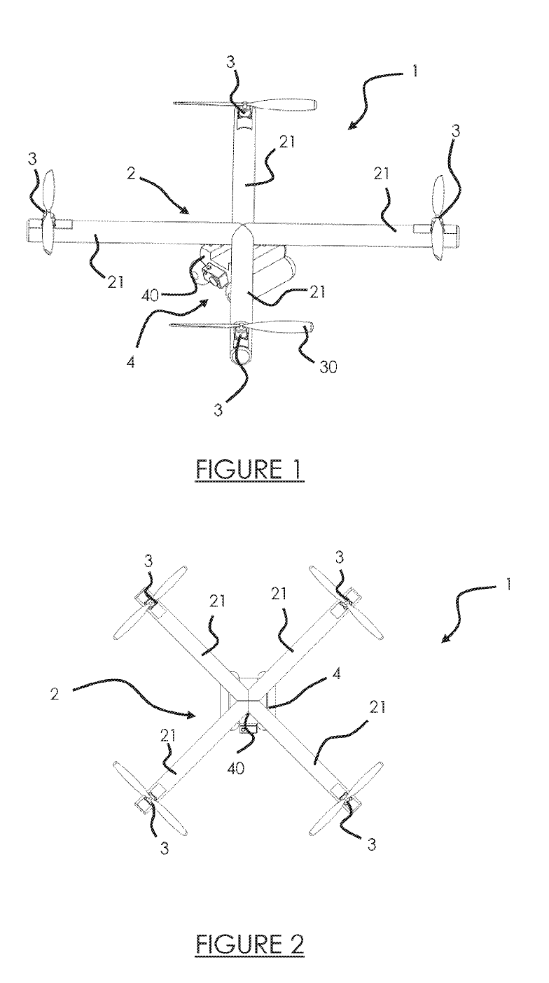

In reference to FIGS. 1 and 2, an unmanned remote-controlled aircraft 1 is shown according to one embodiment of the invention. Hereinafter, the unmanned remote-controlled aircraft 1 will be named drone 1, for the sake of clarity and brevity.

The drone 1 comprises a support structure 2 on which are mounted four motors 3 and a management module 4 to control said motors 3. The drone 1 is a quadricopter.

As shown in FIGS. 1 and 2, the support structure 2 extends in a horizontal plane and has a star-shaped configuration comprising four branches 21. However, there could naturally be a different number of branches. In this example, the branches 21 are spaced angularly at 90° with respect to one another so as to form a symmetrical structure.

Preferably, each branch 21 has a cylindrical cross-section with a diameter ranging from 30 mm to 70 mm. Furthermore, each branch 21 has a length ranging from 30 cm to 70 cm. Naturally, these dimensions could change based on the dimensions of the drone 1.

As shown in FIGS. 4A and 4B, the support structure 2 comprises an inner inflatable shell 5, also called air chamber, and an outer protection shell 6, the inflatable shell 5 being mounted inside the protection shell 6. The protection shell 6 is a structural element of the drone 1, and transfers the mechanical stress generated by the motors 3.

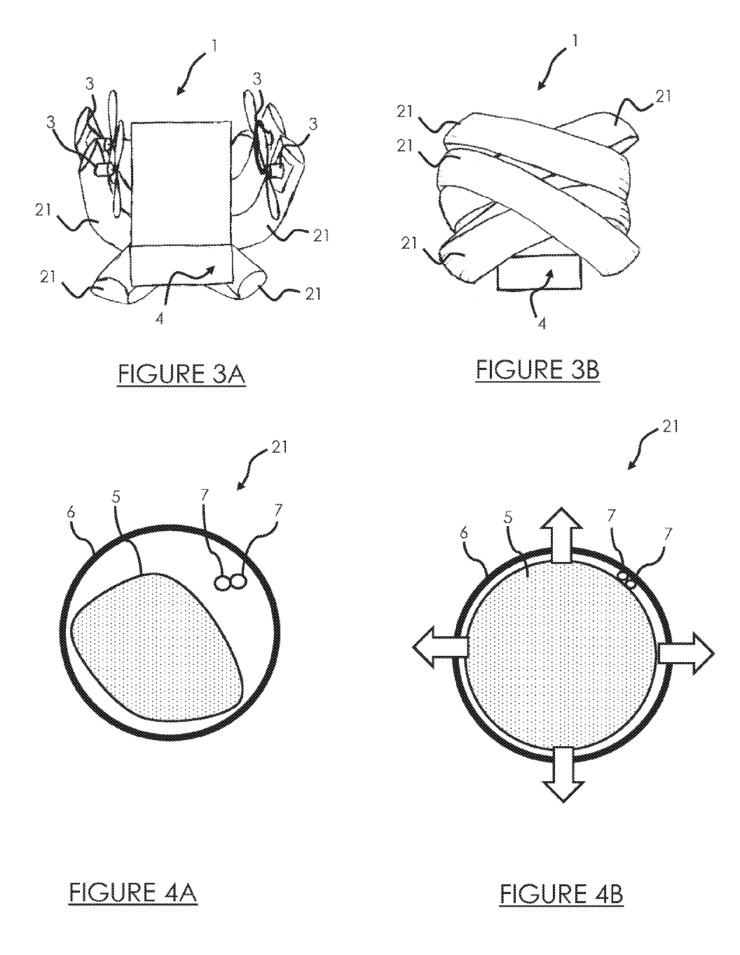

The branches 21 of the support structure 2 can also be folded when the inflatable shell 5 is deflated, which reduces the size of the support structure 2 and therefore, that of the drone 1. In particular, unlike hinges on a rigid arm which can only fold along one axis, a flexible structure provides greater folding freedom of the drone 1, which significantly limits the size thereof as shown in FIGS. 3A and 3B. Advantageously, the branches 21 can be coiled, which enables to optimally position the motors 3 with respect to one another to protect them during transport.

In this example, the inflatable shell 5 is made of polyurethane and has a wall thickness of 80 μm. Naturally, the inflatable shell 5 could have different characteristics. For example, the inflatable shell 5 could be made of latex.

The inflatable shell 5 can be inflated and deflated with a valve preferably positioned at the level of one of the inflatable arms 21 so as to remain easy to access. Preferably, the inner shell 5 is adapted to be inflated to a pressure ranging from 140 MPa (1.4 bar) to 160 MPa (1.6 bar).

The protection shell 6 is preferably made of a material having limited extensibility, to reduce the expansion of the inner shell 5 when it is being inflated. Preferably, the elastic modulus (Young's modulus) thereof is of around 80 GPa. In other words, the protection shell 6 enables to define the final dimensions of the support structure 2 when in use. Preferably, the protection shell 6 is made of a material resistant to impacts and to cuts, for example a material known under the commercial name thereof, DACRON.

In reference to FIGS. 4A and 4B, the support structure 2 also comprises a plurality of basic electric cables 7 arranged between the inflatable shell 5 and the protection shell 6 to connect the motors 3 to the management module 4. Advantageously, the basic electric cables 7 are flexible so that they can be folded with the branches 21. In this example, the centre of the support structure 2 on which is secured the management module 4 is connected to the ends of said branches 21 by said basic electric cables 7. In this example, each basic electric cable 7 comprises a plurality of metal strands mounted in a silicon sleeve, but it could evidently be different.

In this embodiment, in reference to FIG. 6, the protection shell can be open at the axial end of each branch 21 of the support structure 2 in particular, to access the motor 3 mounted at the end of one of the branches 21. In a preferred manner, the protection shell 6 can comprise opening means 22 that can be closed with a hook and loop fastening system, or with a zip fastening system. Naturally, a removable hood or a flexible cover to fill the clearance between the shells 5, 6 can also be used.

In this example, the four motors 3 of the drone 1 are identical and, preferably, known to a person skilled in the art as “brushless” motors. Each motor 3 comprises a propeller 30 that extends above the support structure 2 in the operational mode. However, the propeller 30 could evidently extend under the support structure 2. In this example, each propeller 30 has a diameter ranging from 5 cm to 80 cm, but evidently the diameter could be different, in particular based on the size of the drone 1.

Each motor 3 is connected to the management module 4 by means of 3 basic electric cables 7 to power the motor 3 and regulate to revolution speed of the propeller 30.

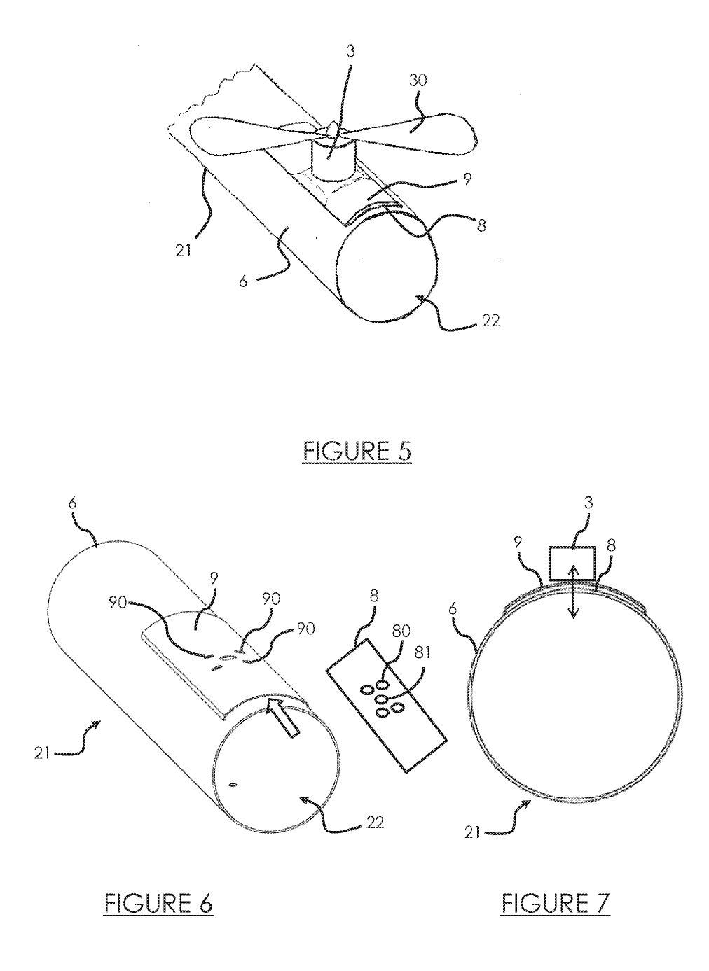

In reference to FIGS. 5 to 7, each motor 3 is secured to the support structure 2 by means of an attachment member 8 that is used to position, in a practical, quick and accurate manner, a motor 3 with respect to the support structure 2. Each motor 3 is here secured to the upper surface of the support structure 2, but it could evidently be secured to the lower surface thereof. The axial end of the inflatable branches 21 is therefore configured to withstand impacts without causing damage to said motors 3.

The attachment member 8 is made of a rigid or plastic material, or of a composite material. In a preferred manner, the attachment member 8 is curved along the width thereof so as to fit to the shape of an inflatable branch 21 in an operational position. The tangential positioning can therefore be accurately adjusted.

In this example, the attachment member 8 comprises several openings 80 in order to allow the passage of connecting parts (screws and similar parts) to secure a motor 3 to the attachment member 8 and to the outer protection shell 6. The attachment member 8 further comprises a central opening 81 for the passage of the axis of the motor 3. Such a central opening 81 can advantageously be used to centre the motor 3 on the attachment member 8 during installation operations.

In this embodiment, the basic electric cable 7 is connected independently to the attachment member 8 in particular, on the outside of the attachment member. In one embodiment (not shown), the attachment member 8 further comprises an opening for the passage of at least one basic electric cable 7 from the inside of the inflatable branch 21 towards the outside, for the purpose of connecting directly to the motor 3. In this example, the openings 80 are circular.

Advantageously, each inflatable branch 21 comprises a sheath 9 secured to the outer shell 6 wherein the attachment member 8 is housed, so as to ensure stable and accurate positioning thereof. In this example, the sheath 9 is formed by securing a separate part to the outer face of the outer shell 6 at the level of the upper section of the support structure 2. Preferably, the separate part is sewn. In reference to FIG. 6, the sheath 9 has transverse openings 90 that are aligned with that of the attachment member 8 when it is mounted, for the purpose of securing the motor 3, the sheath 9 and the attachment member 8 following the insertion and the tightening of screws through the openings 80, 90 from the inside of branch 21.

Preferably, at least some of the openings 90 are oblong so as to allow a positioning clearance when the motor 3 is mounted. This attachment mode allows for the accurate and easy installation of a motor 3 on the inflatable branch 21, in particular for the purpose of adjusting the tangential position. It is therefore useful to ensure that all the axes of the motors 3 are aligned when the drone is in an operational position. The flight capacities thereof are then optimal.

Each attachment member 8 is positioned at the outer end of a branch 21 of the support structure 2, so as to ensure that the motors 3 are optimally spaced from one another.

The management module 4 enables to, preferably, control the motors 3, by adjusting their revolution speed. As shown previously, the management module 4 is connected to the motors 3 by a plurality of basic electric cables 7.

In this example, the management module 4 comprises a battery, for example a Lithium-type battery, power splitters directed towards said motors 3, and an electronic flight command board and a telecommunications receiver, for example of the radio type. Naturally, the management module 4 could comprise more or fewer pieces of equipment.

Optionally, when the drone 1 is adapted to follow a target carried by the user (watch, etc.), the management module 4 can comprise a positioning chip of the GPS-type which can be, optionally, coupled to a Wi-Fi emitter-receiver and an electronic command board to servo the controlling of the drone 1.

In a preferred manner, the management module 4 comprises a rigid member 40 to ensure the accurate parting of the inflatable branches 21 of the drone 1. In this example, the rigid member 40 is in the form of a star secured to the outer protection shell 6, in particular by means of removable attachments preferably of the hook and loop type, so as to remain pushed against the support structure 2. Therefore, during inflation, the branches 21 are perfectly positioned with respect to one another. Preferably, the drone 1 also comprises shock absorbing means (springs, elastic matter, etc.) to limit the motion of the management module 4 with respect to the rigid member 40 connected to the support structure 2 of the drone 1.

In this example, the management module 4 further comprises video equipment configured to take pictures and make recordings which are stored in an internal memory.

In this embodiment, the management module 4 is positioned below the rigid structure 2, but it could naturally be positioned above the rigid structure 2.

An example of an embodiment of the invention is now presented with a user who wishes to remotely control the drone 1 from the side of a mountain to take pictures and record videos.

In this example, the drone 1 is transported in the user's backpack. For this purpose, the support structure 2 is in the storage position. The inner shell 5 is deflated, thereby allowing the branches 21 to be folded along a plurality of points and a plurality of angles (FIGS. 3A and 3B). Advantageously, the motors 3 can easily be positioned next to one another in order to reduce the size of the drone 1. Furthermore, the basic electric cables 7 can fold freely inside the outer shell 6, while being protected by the latter. Advantageously, the outer protection shells 6 of the inflatable branches 21 of the support structure 2 can be positioned so as to cover the motors 3 and the management module 4 to protect them during transport, as shown in FIGS. 3A and 3B.

The user is therefore not hindered by the drone 1 as they scale the side of the mountain. Once in position, the user unfolds the branches 21 of the support structure 2 to inflate it. In this example, the user uses a compressed air cartridge connected to the inflation opening of the inner shell 5 for the purpose of filling it with air. The inner shell 5 is inflated to stretch the outer shell 6 and to rigidify the support structure 2 in the operational position thereof. Once inflated, the motors 3 are accurately positioned so that the axes thereof are parallel to one another. The basic electric cables 7 are pushed against the inner shell 5 and the outer shell 6 as shown in FIG. 4B. The outer shell 6 therefore transfers various stresses to enable the motors 3 to raise the management module 4.

The motors 3 of the drone 1 can then be activated to fly the drone 1 and capture footage. Advantageously, the support structure 2 is resistant to impacts because it is inflatable. Furthermore, thanks to the support structure 2 thereof, the drone 1 can advantageously float on water and take off from water.

To fold the drone 1, simply deflate the inner shell 5 and fold the inflatable branches 21 in a simple and practical manner. The drone 1 can be returned to the user's backpack.

In this example, inflation using a gas cartridge was described because of the small size thereof and the practical nature thereof, but obviously the inner shell 5 could be inflated in different manners, for example using a manual pump.

Naturally, the drone 1 can carry out different missions depending on the equipment it carries (following the user as they are engaged in a sporting activity, etc.). Furthermore, the drone 1 can also be used in military activities, in particular for reconnaissance missions.

If, during operations, one of the motors 3 hits an obstacle, the damaged motor 3 is easily replaceable. Indeed, when the support structure 2 is deflated, the user simply opens the end of the inflatable branch 21 to which the motor 3 is secured to access the connecting parts (screws). The user can loosen the motor 3 from the attachment member 8 and the outer shell 6 to replace said motor 3. The use of this attachment member 8 enables to form a rigid connection with the outer shell 6 that remains flexible.

The assembly of the attachment member 8 in the sheath 9 can be used to adjust the position and tangential angle of the motor 3 so as to ensure the alignment of the axes of the motors 3, which improves the stability of the drone 1.

Maintenance operations of the motors 3 can be conducted in a quick and practical manner.

1. Unmanned, remote-controlled and foldable aircraft comprising at least two motors adapted to fly the aircraft and at least one support structure comprising a plurality of inflatable branches, at least one motor being secured to each inflatable branch, wherein the support structure is flexible and inflatable so as to allow the folding of said support structure, from a storage position to an operational position.

2. Aircraft according to claim 1, wherein the inflatable branches are configured as a star.

3. Aircraft according to claim 1, wherein the support structure comprises an inner inflatable shell and an outer protection shell.

4. Aircraft according to claim 3, wherein the support structure comprises at least one basic electric cable arranged between the inner inflatable shell and an outer protective shell.

5. Aircraft according to claim 1, wherein each inflatable branch comprises opening means providing access to the inner volume of said inflatable branch.

6. Aircraft according to claim 1, wherein each inflatable branch comprises a rigid attachment member used for the attachment of a motor.

7. Aircraft according to claim 1, wherein the support structure comprises an inner inflatable shell and an outer protection shell, wherein each inflatable branch comprises a rigid attachment member used for the attachment of a motor and wherein the attachment member is secured to the outer protection shell.

8. Aircraft according to claim 7, wherein the attachment member is curved so as to fit with the shape of the outer surface of the inflatable branch.

9. Aircraft according to claim 1, wherein the motors are secured to the upper or lower surface of the support structure.

10. Aircraft according to claim 7, wherein the attachment member is secured in a housing of the outer protection shell.
